(19) United States
(12) Patent Application Publication
(10) Pub. No.: US 2006/0004697 A1
(43) Pub. Date: Jan. 5, 2006

(54) Method and system for restricting the display of images

(76) Inventors: Scott E. Lipsky, Seattle, WA (US); Paul Brownlow, Seattle, WA (US)

Correspondence Address: PERKINS COIE LLP;PATENT-SEA, P.O. BOX 1247, SEATTLE, WA, 98111-1247, US

(21) Appl. No.: 10/864,710

(22) Filed: Jun. 9, 2004

(51) Int. Cl. G06F 17/30

(52) U.S. Cl. 707/2

(57) ABSTRACT

A method and system for displaying images that restrict (i.e., prevent) the display of certain images. An image display system is provided with image packages that each include an image plan and images to be displayed. The image plan specifies the sequential display of images and may specify timing, transitioning, panning, and other information relating to the display of the images. The image display system allows a user to define a “restricted attribute condition” that indicates which images are not to be displayed. When the image display system executes an image plan, it selects the next image to be displayed in accordance with the image plan. Prior to displaying the selected image, the image display system determines whether the selected image has attribute values that satisfy a restricted attribute condition. When a restricted attribute condition is satisfied, the image display system suppresses the display of the selected image.

### TECHNICAL FIELD

The described technology relates generally to the presentation of images and particularly to restricting the display of images based on attributes of the images.

### BACKGROUND

The displaying of paintings, sketches, photographs, and other images is very popular in business and personal settings. For example, most homes and offices have paintings or photographs on their walls. It can be very expensive, however, to purchase, maintain, and display high-quality paintings—so much so that most businesses and families cannot afford to do so. As a result, most images that are displayed are low-cost reproductions of high-quality paintings or originals of low-quality paintings. Because viewers can tire of seeing the same painting on a daily basis, some businesses change the location of the paintings that they display to provide more variety to their customers and employees.

Various electronic means have been used to display images to help reduce the cost of displaying images and increase the variety of images that are displayed. For example, slide programs for general-purpose computers have been developed to display images (e.g., stored in JPEG format) on a display device such as a computer monitor. These slide shows typically cycle through displaying a set of images (e.g., defined by a display list) at a fixed rate. Some electronic frames have been developed that allow a user to upload their own photographs for display on a screen within the frame. These electronic frames can, much like a slide show program, cycle through displaying a set of photographs. It can be a time-consuming process, however, to change the set of images that are displayed either by a slide show program or an electronic picture frame. To change a set of images, a person may have to search for, pay for, and download an electronic version of an image and create a display list that includes that image.

An image distribution system has been developed to distribute images from an image distribution server system to image display client systems. The distribution server periodically distributes packages of images to the image display systems for display on a display device (e.g., a high-resolution, flat-panel monitor). The distribution of the image packages can be done with little or no user involvement at the image display systems. Unfortunately, the images in a package may relate to subject matter that some viewers may find objectionable. For example, a package of images relating to Pierre-Auguste Renoir's works may include an image of his “Bathing Woman” painting, which contains partial nudity. The proprietor of a hotel may believe that it is inappropriate to display an image of that painting in a public area of the hotel. One option for the proprietor would be to simply not have any of Renoir's works displayed. Such an approach, however, prevents many desirable works from being displayed. It would be desirable to allow the user of an image display system to restrict or prevent the display of only those images containing subject matter the viewers may find objectionable.

### BRIEF DESCRIPTION OF THE DRAWINGS

FIG. 1 is a display page illustrating the setting of attributes of an image in one embodiment.

FIG. 2 is a display page illustrating the defining of a restricted attribute condition in one embodiment.

FIG. 3 is a display page illustrating the defining of a restricted attribute condition using a Boolean expression in one embodiment.

FIG. 4 is a display page illustrating the restricted attribute conditions that have been defined by an administrator in one embodiment.

FIG. 5 is a block diagram illustrating components of an image distribution system in one embodiment.

FIG. 6 is a flow diagram illustrating the processing of a set restricted attribute condition component in one embodiment.

FIG. 7 is a flow diagram illustrating the processing of a modify image plan component in one embodiment.

FIG. 8 is a flow diagram illustrating the processing of a restricted attribute condition satisfied function in one embodiment.

### DETAILED DESCRIPTION

A method and system for displaying images that restricts (i.e., prevents) the display of certain images is provided. In one embodiment, an image display system is provided with image packages that each include an image plan and images to be displayed. The image plan specifies the sequential display of images and may specify timing, transitioning, panning, and other information relating to the display of the images. Each image may also have attributes, such as class and category, associated with it. For example, a class attribute may specify whether the image is a photograph or an abstract work of art. The category attribute may specify whether the image contains certain categories of subject matter that viewers may find objectionable, such as nudity, tobacco, drugs, and so on. The attributes of each image may be specified by a person prior to distribution of the image by an image distribution server to an image display system. The attribute values may be stored as metadata or properties of a file that contains an image. The image display system allows a user, such as an administrator, to define a “restricted attribute condition” that indicates which images are not to be displayed. For example, a restricted attribute condition may specify that images with a class of “photograph” and category of “nudity” should be restricted. In one embodiment, a restricted attribute condition may be specified as a Boolean expression of arbitrary complexity. When the image display system executes an image plan, it selects the next image to be displayed in accordance with the image plan. Prior to displaying the selected image, the image display system determines whether the selected image has attribute values that satisfy a restricted attribute condition. For example, given the example restricted attribute condition described above, any image with a class of “photograph” and a category of “nudity” satisfies the restricted attribute condition. When a restricted attribute condition is satisfied, the image display system suppresses the display of the selected image. In one embodiment, the image display system selects the next image of the image plan and displays it, assuming that it does not satisfy any restricted attribute conditions. The image display system displays that next image after the display of the previous image as if the restricted out image had never been included in the image plan. In this way, a viewer of the images cannot detect that an image has been restricted out and an administrator of the image display system can specify attributes of images that may be objectionable and should be restricted out.

In one embodiment, the image display system allows an administrator to specify multiple restricted attribute conditions such that if any one of the restricted attribute conditions is satisfied by an image, then the image is restricted out. The image display system may allow the administrator to name each restricted attribute condition for easy identification and modification. For example, a restricted attribute condition may be named “politically incorrect” when its purpose is to restrict out images that may contain politically incorrect subject matter. The image display system may also allow the administrator to specify dates and times when a restricted attribute condition is to be applied. For example, a restricted attribute condition that restricts out images involving nudity may be applied between the hours of 6 a.m. and 9 p.m. when children are likely to be viewing the images. The restricted attribute conditions may be specified using any attributes associated with the images such as class, category, artists, collection, and so on. For example, an administrator may want to restrict out all images of paintings by a certain artist. The image display system may serially apply each restricted attribute condition to an image. If any one of the restricted attribute conditions is satisfied, then the image display system restricts out that image. The restricting out of images can be performed dynamically as each image is selected to be displayed, when an image plan is received from the image distribution server, when an image plan is selected for execution, and so on.

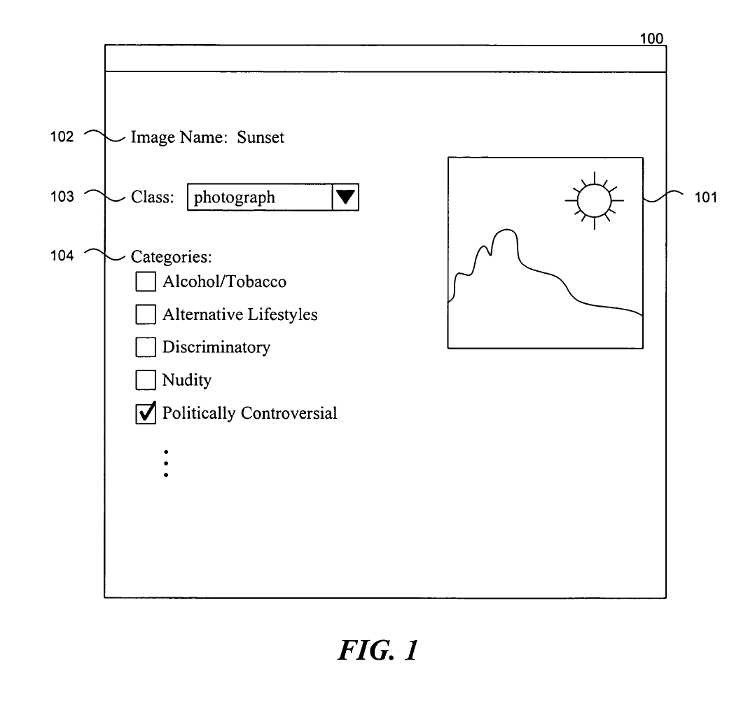

FIG. 1 is a display page illustrating the setting of attributes of an image in one embodiment. The display page 100 includes an image display area 101, an image name field 102, a class attribute drop-down list 103, and category checkboxes 104. The image distribution server presents this display page to a user so that the user can specify the attributes of the image. In this example, the class attribute values can be set to “photograph/photorealistic,” “painting/abstract,” or “other.” The category attribute values can be “alcohol/tobacco/gambling/drugs,” “alternative lifestyles (sexual),” “discriminatory/prejudicial,” “nudity,” “politically controversial,” “religious icons,” “sexual/passionate content,” and “violent/weapons.” One skilled in the art will appreciate that many different categories can be defined and that an image may fall into multiple categories. For example, an image may have category attribute values of “politically controversial” and “religious icons.” In addition, the categories may be hierarchically organized. For example, a “vice” category may have subcategories of “alcohol,” “tobacco,” “gambling,” and “drugs.” The image display system may allow an administrator to specify categories and subcategories within a restricted attribute condition. For example, an administrator may want to restrict out images relating to alcohol, tobacco, and drugs, but not relating to gambling. The image display system may also allow a named restricted attribute condition to be used within another restricted attribute condition. For example, an administrator may define a restricted attribute condition named “sexual” that is satisfied when an image has a category attribute value of “alternative lifestyles (sexual),” “nudity,” or “sexual/passionate content.” That restricted attribute condition may be part of another restricted attribute condition named “religious sexual” that is satisfied when the category attribute value is “religious icons” and the “sexual” restricted attribute condition is satisfied. In such a case, the “sexual” restricted attribute condition may be set to inactive so that it will not be applied individually to the images.

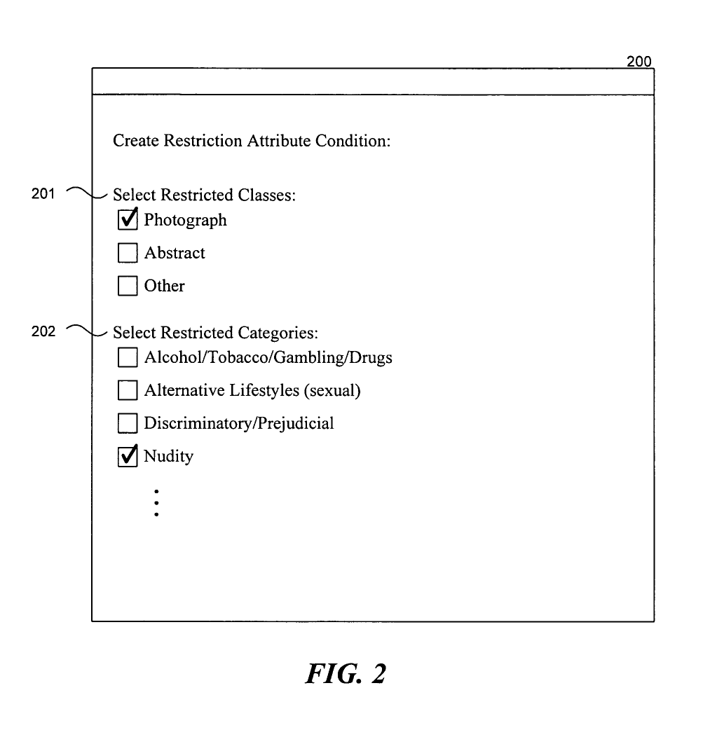

FIG. 2 is a display page illustrating the defining of a restricted attribute condition in one embodiment. The display page 200 includes a class selection area 201 and a category selection area 202. An administrator uses this display page to specify the restricted classes and categories. In this example, the administrator has specified that images with both a class attribute value of “photograph” and a category attribute value of “nudity” are to be restricted out. The image display system in one embodiment creates a Boolean expression for the restricted attribute condition.

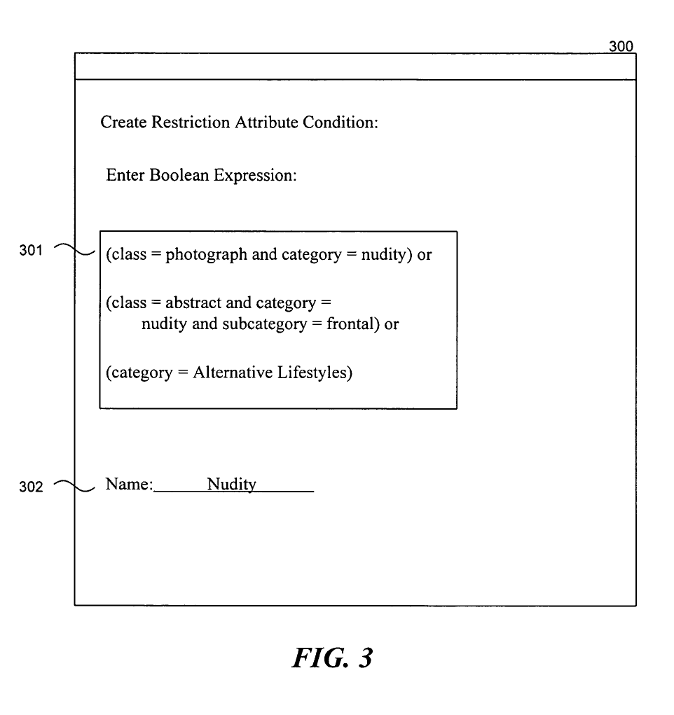

FIG. 3 is a display page illustrating the defining of a restricted attribute condition using a Boolean expression in one embodiment. The display page 300 includes a Boolean expression area 301 and a name field 302. An administrator enters a Boolean expression of arbitrary complexity (i.e., using any combination of attribute values and the Boolean operators “and,” “or,” “not,” and so on) in the Boolean expression area. In this example, the administrator has specified a Boolean expression that is satisfied when the class attribute value is “photograph” and the category attribute value is “nudity,” or the class attribute value is “abstract” and the category attribute value is “nudity” and the subcategory attribute value is “frontal,” or the category attribute value is “alternative lifestyle.” The administrator has named this Boolean expression “nudity” as indicated by the name field.

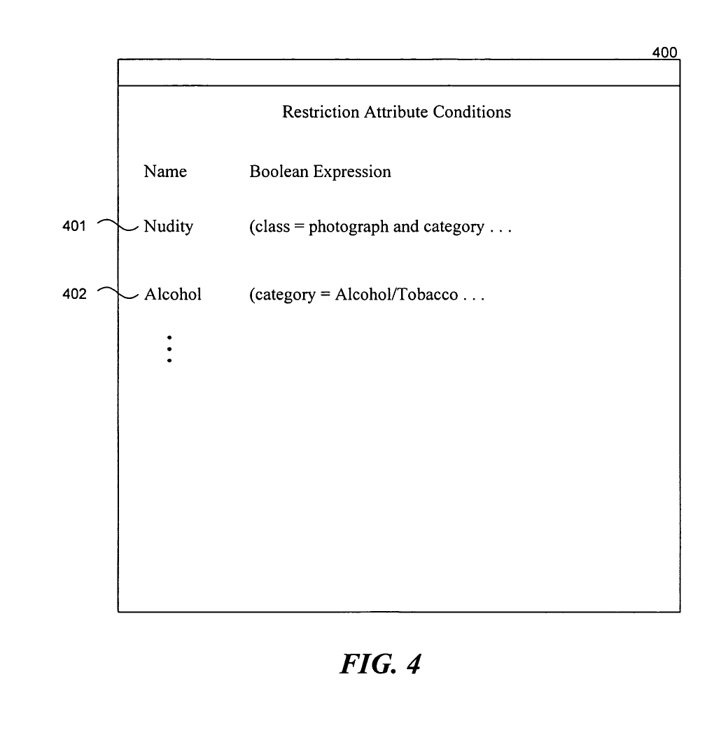

FIG. 4 is a display page illustrating the restricted attribute conditions that have been defined by an administrator in one embodiment. The display page 400 includes Boolean expression rows 401 and 402. Row 401 indicates that a Boolean expression named “nudity” (e.g., corresponding to the expression of FIG. 3) has been defined, and row 402 indicates that a Boolean expression named “alcohol” has been defined. An administrator may select one of the rows to edit its Boolean expression. Although not illustrated, each row may include a field to indicate whether the Boolean expression is currently active and may also include an indication of the schedule for applying the Boolean expression.

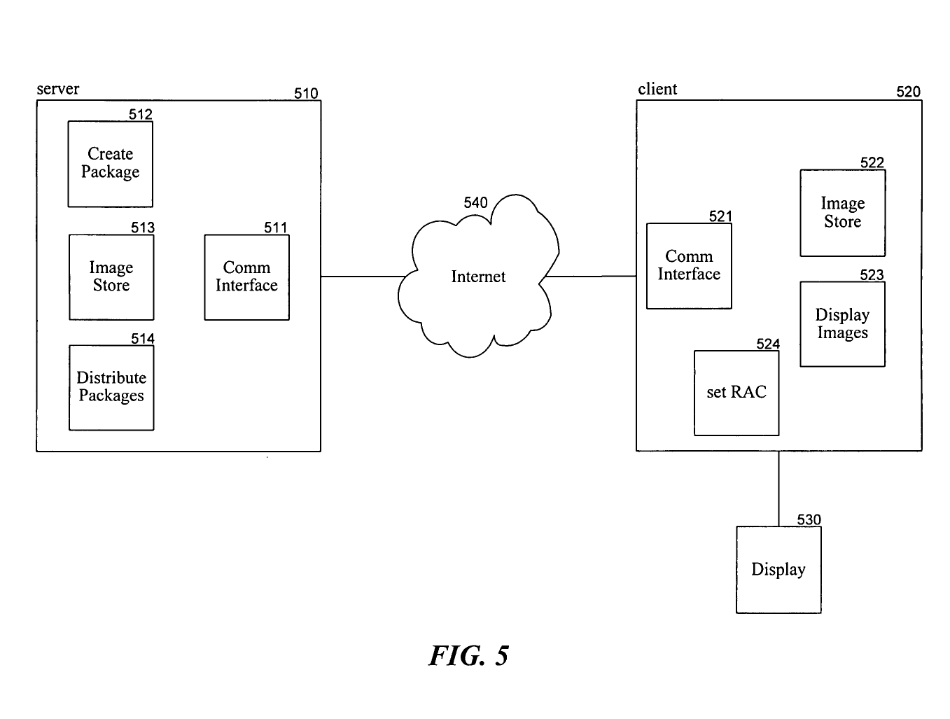

FIG. 5 is a block diagram illustrating components of an image distribution system in one embodiment. The image distribution system includes an image distribution server system 510 and an image display client system 520 interconnected via a communications link 540, such as the Internet. The image distribution server includes a communications interface 511, a create package component 512, an image store 513, and a distribute package component 514. The image store contains packages, images, and image plans. The create package component is used by a user to manipulate the images and create image plans and image packages. The create package component also allows a user to specify the attributes of each image, for example, using the display page of FIG. 1. The distribute package component is responsible for distributing the image packages to the appropriate image display systems at designated times. The communications interface 511 provides the communications interface to the communications link. The image display system includes a communications interface 521, an image store 522, a display images component 523, and a set restricted attribute condition component 524. The image display system is connected to a display device 530. The communications interface receives image packages from the image distribution server and stores the image packages in the image store. The image store may also include the restricted attribute conditions that have been defined by an administrator of the image display system. The display images component displays images in accordance with the image plans of the image store. The display images component also restricts out images in accordance with the restricted attribute conditions. The set restricted attribute condition component allows the administrator to create, modify, and delete the restricted attribute conditions.

The client systems and server system may include a central processing unit, memory, input devices (e.g., keyboard and pointing devices), output devices (e.g., display devices), and storage devices (e.g., disk drives). The memory and storage devices are computer-readable media that may contain instructions that implement the image distribution system. In addition, the data structures and message structures may be stored or transmitted via a data transmission medium such as a signal on a communications link. Various communications links, other than the Internet, may be used such as a local-area network, a wide-area network, or a point-to-point dial-up connection.

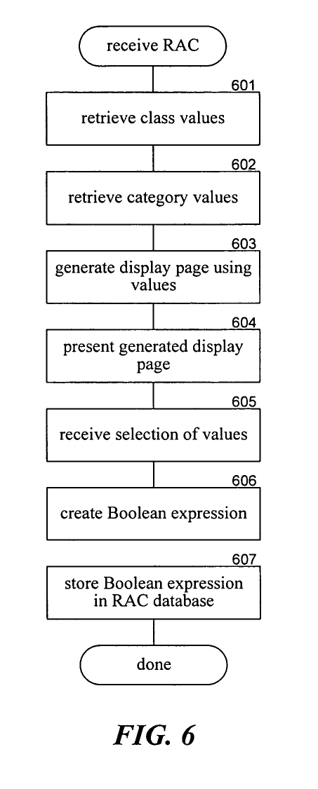

FIG. 6 is a flow diagram illustrating the processing of a set restricted attribute condition component in one embodiment. The component allows an administrator to define a restricted attribute condition and stores a Boolean expression representing that condition in the image store. This component implements the function of FIG. 2. In block 601, the component retrieves the possible class values. In block 602, the component retrieves the possible category values. The possible values may be statically defined or may be dynamically defined in updates distributed by the image distribution server. For example, a new category of “sports” with subcategories of “football” and “baseball” may be defined for use with a package of sports-related images. In block 603, the component generates a display page using the retrieved values, such as the display page of FIG. 2. In block 604, the component presents the generated display page to the administrator. The administrator can then select the appropriate attribute values. In block 605, the component receives the selected attribute values. In block 606, the component creates a Boolean expression representing a restricted attribute condition based on the selected attribute values. In block 607, the component stores the Boolean expression in the image store and then completes.

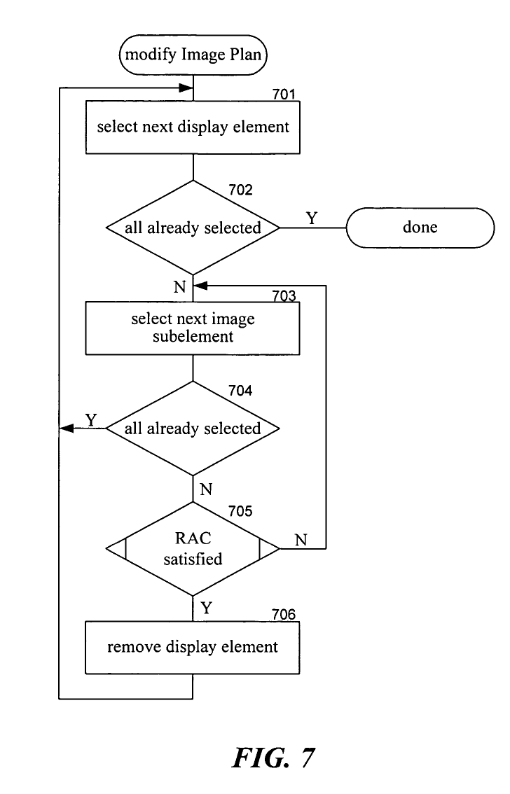

FIG. 7 is a flow diagram illustrating the processing of a modify image plan component in one embodiment. The component modifies an image plan to remove instructions for displaying any image that satisfies a restricted attribute condition. The component may be invoked when a package is received, when a package is about to be displayed, when a restricted attribute condition is modified, and so on. The format of an image plan in one embodiment is described in U.S. patent application Ser. No. 10/704,211, entitled “Method and System for Displaying Multiple Aspect Ratios of a Viewport.” The format specifies that various XML image display elements are used to specify the display of an image. The XML image display element may include “xfade,” “pan,” and “display” elements. In block 701, the component selects the next image display element of the image plan. In decision block 702, if all the image display elements have already been selected, then the component completes, else the component continues at block 703. In block 703, the component selects the next image subelement of the selected image display element. An image subelement specifies the name of the file that contains the image that is to be displayed in accordance with the image display element. In decision block 704, if all the image subelements of the selected image display element have already been selected, then the component loops to block 701 to select the next image display element, else the component continues at block 705. In block 705, if a restricted attribute condition is satisfied, then the component continues at block 706, else the component loops to block 703 to select the next image subelement of the selected image display element. In block 706, the component removes the image display element from the image plan and loops to block 701 to select the next image display element. Alternatively, the component may set a flag on the selected image display element to indicate that it should be restricted out.

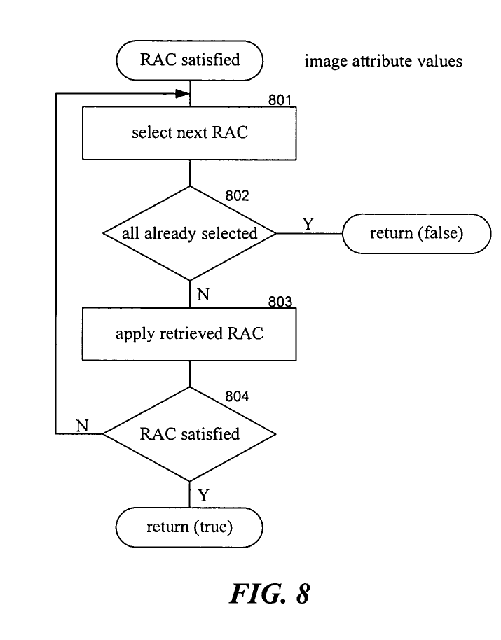

FIG. 8 is a flow diagram illustrating the processing of a restricted attribute condition satisfied function in one embodiment. This function is passed image attribute values and returns a flag indicating whether a restricted attribute condition is satisfied. This function may be invoked dynamically as images are displayed or by the modify image plan component. In block 801, the function selects the next restricted attribute condition from the image store. In decision block 802, if all the restricted attribute conditions have already been selected, then none have been satisfied and the function returns an indication that none have been satisfied, else the function continues at block 803. In block 803, the function applies the retrieved restricted attribute condition to the passed image attribute values. In decision block 804, if the restricted attribute condition is satisfied, then the function returns an indication that a restricted attribute condition is satisfied, else the function loops to block 801 to select the next restricted attribute condition.

One skilled in the art will appreciate that although specific embodiments of the distribution system have been described herein for purposes of illustration, various modifications may be made without deviating from the spirit and scope of the invention. For example, one skilled in the art will appreciate that an “overriding attribute condition” may be defined indicating that any image that satisfies the condition will be displayed even though it may also satisfy a restricted attribute condition. Accordingly, the invention is not limited except by the appended claims.

I/We claim:

1. A method in a computer system for displaying images, the method comprising:
providing an image package including an image plan and images, the image plan defining a sequential display of the images, each image having an attribute value;
receiving from a user a restricted attribute condition indicating that images with an attribute value that satisfies the restricted attribute condition are not to be displayed; and
executing the image plan to display the images by
selecting the next image to be displayed in accordance with the image plan;
determining whether the selected image has an attribute value that satisfies the restricted attribute condition;
when it is determined that the selected image has an attribute value that satisfies the restricted attribute condition, suppressing the display of the selected image; and
when it is determined that the selected image does not have an attribute value that satisfies the restricted attribute condition, displaying the selected image,
wherein when the display of an image is suppressed, the next image of the image plan that does not have an attribute value that satisfies the restricted attribute condition is displayed after the display of a previous image.

2. The method of claim 1 wherein the attribute is a category attribute.

3. The method of claim 2 wherein the values of the category attribute values include “alcohol/tobacco/gambling/drugs,” “alternative lifestyles (sexual),” “discriminatory/prejudicial,” “nudity,” “politically controversial,” “religious icons,” “sexual/passionate content,” and “violent/weapons.”

4. The method of claim 1 wherein each image has a class attribute and a category attribute and the restricted attribute condition specifies a combination of class attribute value and category attribute value.

5. The method of claim 4 wherein the class attribute values include photograph and abstract.

6. The method of claim 1 wherein the restricted attribute condition specifies a Boolean combination of attribute values.

7. The method of claim 1 wherein the restricted attribute condition specifies a Boolean combination of attribute values for different attributes.

8. The method of claim 1 including:
after executing the image plan,
receiving a new restricted attribute condition; and
executing the image plan in accordance with the new restricted attribute condition.

9. The method of claim 1 wherein the providing of the image package includes receiving the image package from an image distribution server via a communications link.

10. The method of claim 1 wherein the providing of the image package includes retrieving the image package from a tangible medium upon which an image distribution server stored the image package.

11. A method in a computer system for modifying an image plan, the method comprising:
providing an image package including an image plan and images, the image plan specifying a sequential display of the images, each image having an attribute value;
receiving from a user a restricted attribute condition indicating that images with an attribute value that satisfies the restricted attribute condition are not to be displayed; and
for each image of the image plan,
determining whether the image has an attribute value that satisfies the restricted attribute condition; and
when it is determined that the image has an attribute value that satisfies the restricted attribute condition, adjusting the image plan so that the image is not displayed as part of the image plan and so that an image that does not have an attribute value that satisfies the restricted attribute condition is displayed after the display of a previous image of the image plan.

12. The method of claim 11 including executing the image plan as adjusted.

13. The method of claim 11 include maintaining a copy of the provided image package before any adjustments are made.

14. The method of claim 11 wherein the attribute is a category attribute.

15. The method of claim 14 wherein the values of the category attribute values include “alcohol/tobacco/gambling/drugs,” “alternative lifestyles (sexual),” “discriminatory/prejudicial,” “nudity,” “politically controversial,” “religious icons,” “sexual/passionate content,” and “violent/weapons.”

16. The method of claim 11 wherein each image has a class attribute and a category attribute and the restricted attribute condition specifies a combination of class attribute value and category attribute value.

17. The method of claim 16 wherein the class attribute values include photograph and abstract.

18. The method of claim 11 wherein the restricted attribute condition specifies a Boolean combination of attribute values.

19. The method of claim 11 wherein the restricted attribute condition specifies a Boolean combination of attribute values for different attributes.

20. The method of claim 11 including:
after modifying the image plan,
receiving a new restricted attribute condition; and
adjusting the image plan in accordance with the new restricted attribute condition.

21. The method of claim 11 wherein the providing of the image package includes receiving the image package from an image distribution server via a communications link.

22. The method of claim 11 wherein the providing of the image package includes retrieving the image package from a tangible medium upon which an image distribution server stored the image package.

23. A method in a computer system for distributing image packages to display systems, the method comprising:
for a plurality of images,
displaying the image to a user; and
receiving from the user an indication of a category attribute value for a category attribute to be assigned to the image;
receiving from a user an image plan that identifies a sequence of images to be displayed;
generating an image package that specifies the image plan, images of the image plan, and the category attribute value of each image; and
sending the generated image package to image display systems wherein an image display system restricts the display of the images of the sent image package based on the category attribute value of the images and a restricted attribute condition specified by a user of the image display system.

24. The method of claim 23 wherein each image has a class attribute with a class value and the restricted attribute condition is based on a combination of a class attribute value and a category attribute value.

25. The method of claim 24 wherein the class attribute values include photograph and abstract.

26. The method of claim 23 wherein the restricted attribute condition specifies a Boolean combination of category attribute values.

27. The method of claim 23 wherein an image display system dynamically identifies restricted images as the image plan is being executed.

28. The method of claim 23 wherein a display system statically adjusts the image plan based on the restricted images.

29. The method of claim 23 wherein the sending includes sending via a communications link.

30. The method of claim 23 wherein the sending includes encoding the image package on a tangible medium.

31. A computer-readable medium containing instructions for controlling a computer system to display images, by a method comprising:
providing an image plan and images, the image plan defining a sequential display of the images, each image having an attribute value;
receiving from a user a restricted attribute condition indicating that images with an attribute value that satisfies the restricted attribute condition are not to be displayed; and
executing the image plan to display images of the image plan wherein images whose attribute values satisfy the restricted attribute condition are not displayed.

32. The computer-readable medium of claim 31 wherein the executing of the image plan includes:
selecting the next image to be displayed in accordance with the image plan;
determining whether the selected image has an attribute value that satisfies the restricted attribute condition;
when it is determined that the selected image has an attribute value that satisfies the restricted attribute condition, suppressing the display of the selected image; and
when it is determined that the selected image does not have an attribute value that satisfies the restricted attribute condition, displaying the selected image,
wherein when the display of an image is suppressed, the next image of the image plan that does not have an attribute value that satisfies the restricted attribute condition is displayed after the display of a previous image.

33. The computer-readable medium of claim 31 wherein a viewer cannot detect that an image has not been displayed.

34. The computer-readable medium of claim 31 wherein no indication is displayed that an image has not been displayed.

35. The computer-readable medium of claim 31 wherein the attribute is a category attribute.

36. The computer-readable medium of claim 35 wherein the values of the category attribute values include “alcohol/tobacco/gambling/drugs,” “alternative lifestyles (sexual),” “d iscriminatory/prejudicial,” “nudity,” “politically controversial,” “religious icons,” “sexual/passionate content,” and “violent/weapons.”

37. The computer-readable medium of claim 31 wherein each image has a class attribute and a category attribute and the restricted attribute condition specifies a combination of class attribute value and category attribute value.

38. The computer-readable medium of claim 31 including:
after executing the image plan,
receiving a new restricted attribute condition; and
executing the image plan in accordance with the new restricted attribute condition.

39. The computer-readable medium of claim 31 wherein the providing of the image plan includes receiving the image plan from an image distribution server via a communications link.

40. The computer-readable medium of claim 31 wherein the providing of the image plan includes retrieving the image plan from a tangible medium upon which an image distribution server stored the image plan.

41. A computer-readable medium containing instructions for controlling a computer system to distribute image packages to display systems, by a method comprising:
for a plurality of images, receiving from a user an indication of a category attribute value for a category attribute to be assigned to the image;
receiving from the user an image plan that identifies a sequence of images to be displayed;
generating an image package that specifies the image plan, images of the image plan, and the category attribute value of each image; and
sending the generated image package to an image display system wherein the image display system restricts the display of the images of the sent image package based on the category attribute value of the images and a restricted attribute condition specified by the user of the image display system.

42. The computer-readable medium of claim 41 wherein each image has a class attribute with a class value and the restricted attribute condition is based on a combination of a class attribute value and a category attribute value.

43. The computer-readable medium of claim 41 wherein an image display system dynamically identifies restricted images as an image plan is being executed.

44. The computer-readable medium of claim 41 wherein a display system statically adjusts the image plan based on the restricted images.

45. The computer-readable medium of claim 41 wherein the sending includes sending via a communications link.
